(19) United States
(12) Patent Application Publication
(10) Pub. No.: US 2015/0106478 A1
(43) Pub. Date: Apr. 16, 2015

(54) FILE HANDLERS SUPPORTING DYNAMIC DATA STREAMS

(71) Applicant: Microsoft Corporation, Redmond, WA (US)

(72) Inventors: Eli Zeitlin, Bellevue, WA (US); Mauro Luigi Drago, Redmond, WA (US); Gokhan Ozhan, Redmond, WA (US)

(73) Assignee: Microsoft Corporation, Redmond, WA (US)

(21) Appl. No.: 14/053,917

(22) Filed: Oct. 15, 2013

(51) Int. Cl. H04L 29/08; H04L 29/06; G06F 17/30

(52) U.S. Cl. CPC H04L 67/06; G06F 17/30569; H04L 65/60
USPC 709/219

(57) ABSTRACT

Various techniques for dynamically generating data streams from files are described herein. In one embodiment, a method includes receiving a request from an application to open a file. The request has a file identifier identifying the file, an attribute designator, and a data attribute delineated from the file identifier by the attribute designator. The method also includes retrieving data of at least a portion of the file based on the determined file identifier and dynamically generating a data stream of the file in response to the received request to open the file by transforming the retrieved data according to the data attribute of the request. The method further includes supplying the generated data stream to the application.

### BACKGROUND

Computers, smartphones, tablets, and other computing devices can facilitate creation, manipulation, organization, and other tasks related to managing data. For example, users may create new files, open existing files, save edited files, close opened files with or without saving, and/or perform other data management tasks on the computing devices. A user may also group certain data files in directories or folders for ease of access and/or organization.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In certain situations, computing devices may experience difficulties in performing certain data management tasks. For example, a computing device may not properly process a file if the particular format of the file is not supported by an operating system or application of the computing device. In another example, a computing device may not access a file if a size of the file exceeds a certain threshold. One solution to the foregoing difficulties may be using a utility program to convert the file into a compatible format, or to split the file into smaller files, or using a converter within each application to convert the file to a new format. However, such a utility program or converter may not be readily available. Even if available, using the utility program may still be cumbersome and inefficient.

Several embodiments of the present technology can address at least some of the foregoing difficulties by providing a file handler that supports dynamic generation of data streams from a file based on one or more particular data attributes in response to a file request. In certain embodiments, a requestor (e.g., an application) may request a file and designate a file format, size, segment, version, and/or other data attributes of the requested file. In response, the file handler can generate a data stream based on the file according to the designated data attribute(s) and return the generated data stream to the requestor. In other embodiments, the file handler may be configured to automatically detect one or more of the data attributes based on requestor data, and generate a data stream accordingly. In further embodiments, the file handler may be configured to determine that a file request is likely to fail, for example, when the requested file is too large or not in a suitable file format for the requestor. In response, the file handler may be configured to generate a data stream of the requested file based on one or more detected and/or default data attributes. As a result, the risk of an execution failure may be reduced or avoided.

### BRIEF DESCRIPTION OF THE DRAWINGS

FIG. 1 is a schematic block diagram illustrating a computer framework having a file handler supporting dynamic data streams in accordance with embodiments of the present technology.

FIG. 2 is a block diagram showing software modules suitable for the file handler of FIG. 1 in accordance with embodiments of the present technology.

FIG. 3 is a flow diagram illustrating a process of dynamically generating data streams in accordance with embodiments of the present technology.

FIG. 4A is a flow diagram illustrating embodiments of a process of dynamically generating data streams in accordance with embodiments of the present technology.

FIG. 4B is a flow diagram illustrating embodiments of a process of checking compatibility in accordance with embodiments of the present technology.

FIG. 5 is a computing device suitable for certain components of the computer framework in FIG. 1.

### DETAILED DESCRIPTION

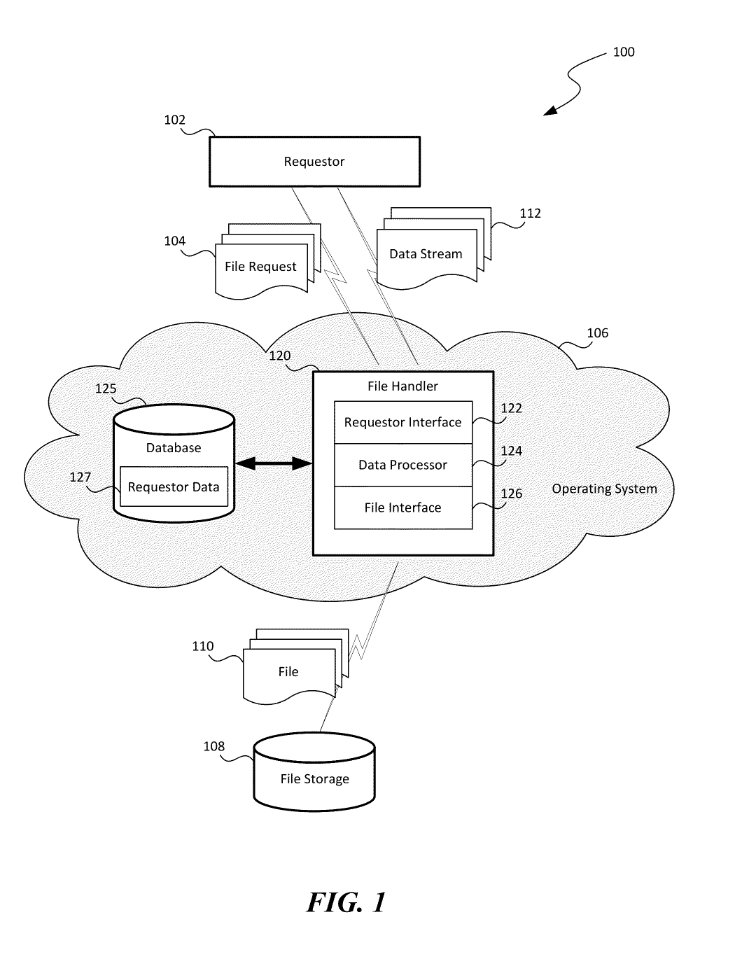

Certain embodiments of systems, devices, components, modules, routines, and processes for dynamically generating data streams from files are described below. In the following description, example software codes, values, and other specific details are included to provide a thorough understanding of certain embodiments of the present technology. A person skilled in the relevant art will also understand that the technology may have additional embodiments. The technology may also be practiced without several of the details of the embodiments described below with reference to FIGS. 1-5.

As used herein, the term “file” may refer to any suitable data container in a file system. For example, a file may be an application file, a data file, a directory, a subdirectory, a logical unit number, and/or other suitable types of data container. Also used herein, the term “file handler” generally refers to one or more computer software components, modules, routines, or other facilities configured to cooperatively perform certain data management tasks. For example, a file handler may include one or more data extraction facilities configured to extract a beginning, intermediate, end, or another suitable portion of a file. In another example, a file handler may include one or more compression facilities configured to reduce a size of a file to a target value. In yet another example, a file handler may include one or more data conversion facilities configured to convert a file from an original file format to a target file format. In further examples, a file handler may include a combination of the foregoing and/or other suitable processing facilities. In certain embodiments, the file handler can be a facility of a file system in an operating system, as described with reference to FIG. 1. In other embodiments, the file handler can also be a facility of an application, a plug-in or extension to an application, or be in other suitable forms.

Also used herein, the term “file identifier” generally refers to information necessary to identify a file. In certain embodiments, a file identifier can include a file name and an optional file extension. In other embodiments, a file identifier can also include a file path that identifies a logical and/or physical location of the file. In further embodiments, a file identifier may also include a version number, a modification date, and/or other suitable information.

Further as used herein, the term “attribute designator” generally refers to a text, symbol, punctuation, or other suitable types of character that indicates a data attribute to a file handler. A data attribute can include a size (e.g., 100 Mb, 200 Mb, etc.), format (e.g., JPEG, PDF, etc.), or segment (e.g., head or end) of the requested file. In the following description, the symbol “@” is used as an example attribute designator for illustration purposes. However, in other embodiments, the attribute designator may include another suitable character, symbol, or punctuation.

As discussed above, computing devices may experience difficulties in performing certain data management tasks in certain situations. Several embodiments of the present technology can address at least some of the foregoing difficulties by incorporating a file handler into an operating system or application of a computing device. For example, in certain embodiments, the file handler can be configured to transform a requested file based on one or more data attributes included in a file request. In other embodiments, the file handler may automatically detect one or more of the data attributes, and then generate one or more data streams based on the detected data attributes, as described in more detail below with reference to FIGS. 1-5.

FIG. 1 is a schematic block diagram illustrating a computer framework 100 having a file handler supporting dynamic data streams in accordance with embodiments of the present technology. In FIG. 1 and in other Figures hereinafter, individual software components, modules, and routines may be a computer program, procedure, or process written as source code in C, C++, Java, and/or other suitable programming languages. The computer programs, procedures, or processes may be compiled into intermediate, object or machine code and presented for execution by a processor of a personal computer, a network server, a laptop computer, a smart phone, a tablet, and/or other suitable computing devices. Various implementations of the source, intermediate, and/or object code and associated data may be stored in one or more computer readable storage media that include read-only memory, random-access memory, magnetic disk storage media, optical storage media, flash memory devices, and/or other suitable media. As used herein, the term “computer readable storage medium” excludes propagated signals, per se.

As shown in FIG. 1, the computer framework 100 can include a file handler 120 and database 125, a requestor 102, and a file storage 108 operatively coupled to one another. In certain embodiments, at least some of the foregoing components may reside on a single computing device (e.g., a computer) and be operatively coupled to one another via a computer bus (not shown). In other embodiments, the foregoing components may reside on multiple computing devices (e.g., servers, computers, or smartphones) and operatively coupled to one another via a communication network (e.g., an intranet, the Internet, etc.). For example, the file storage 108 may reside on one or more remote servers (not shown) connected to the file handler via the communication network. Even though the file handler 120 is shown in FIG. 1 as a component (e.g., as a kernel-mode driver) of an operating system 106, in other embodiments, at least one of the file handler 120 or the database 125 may be a component of an application (e.g., as a user-mode dynamic link library), a plug-in or extension to an application, or in other suitable forms. Examples of the operating system 106 can include Microsoft Windows®, Apple OS®, Solaris® operating system, Android® operating system, and/or other suitable types of operating system that supports one or more data streams in a file system associated with the operating system.

The requestor 102 may include an application or an application component (e.g., a user mode dynamic link library) executing on the operating system 106 or a remote application. The requestor 102 can be configured to accept an input from a user (not shown) and transmit a file request 104 based on the accepted input to the file handler 120. For example, in one embodiment, the file request 104 can include a request to open one or more files in the file storage 108. In other embodiments, the file request 104 can include a request to save, close, and/or otherwise access one or more files in the file storage 108.

The file request 104 may include a string with a file identifier and one or more sets of optional attribute identifiers and data attributes. In certain embodiments, the data attributes in the file request 104 may be compositional and can be interpreted in sequence with left associativity (or other suitable types of associativity). For instance, the file request 104 can include a request to open a file 110 (e.g., “oldfile.txt”) in the file storage 108. In one example, the file request 104 may include the following string:

C:\filedirectory\oldfile.txt@head@ToDOC

As shown above, the example file request 104 includes a file identifier (i.e., “C:\filedirectory\oldfile.txt”) that has a file path (i.e., “C:\filedirectory\”), a file name (i.e., “oldfile”), and a file extension (i.e., “txt”). The example file request 104 also includes two sets of attribute designators and data attributes. The first set includes a first attribute designator “@” and the string “head” indicating a request for a beginning segment of the requested file of a certain size (e.g., 10 Mb). The second set includes a second attribute designator “@” and the string “ToDOC” indicating the requested file to be provided in the Microsoft Word® format. In another example, the file request 104 may include the following string:

C:\filedirectory\oldfile.txt@[10mb]@ToDOC

In the foregoing example, the first set includes the first attribute designator “@” and the string “[10mb]” indicating a request for 10 Mb of the requested file. In other examples, the file request 104 may only include one, three, four, or any other suitable number of sets of the foregoing and/or other suitable attribute designators and data attributes. In yet other examples, the file identifier may include a null value for both the file name and the file extension. For instance, the file request 104 may include the following string:

C:\filedirectory\@ToCSV

In the foregoing example, only the file path (i.e., “C:\filedirectory\”) is identified with the data attribute “ToCSV” indicating a request for a data stream in CSV format of names, sizes, and/or other suitable information of one or more subdirectories or files in the “C:\filedirectory\” directory. In further examples, the file request 104 may be interpreted in other suitable orders or manners, and may not include any attribute designators or data attributes. Instead, the file handler 120 may automatically detect certain data attributes for the requestor 102, as discussed in more detail below.

Based on the received file request 104, the file handler 120 can be configured as a file request handler or a file content handler that retrieves the requested file 110 according to the various data attributes designated by the attribute designators. As shown in FIG. 1, the file handler 120 can include a requestor interface 122, a data processor 124, and a file interface 126 operatively coupled to one another. Even though the file handler 120 is shown to include the foregoing components in FIG. 1, in other embodiments, the file handler 120 may also include a database component, a network interface, and/or other suitable components in addition to or in lieu of the foregoing components.

The requestor interface 122 can include an interface component suitable to receive the file request 104 from as well as provide one or more data streams 112 to the requestor 102. For example, in one embodiment, the requestor interface 122 can include a user-mode application programming interface (“API”). In another embodiment, the requestor interface 122 can include a kernel-mode API. In further embodiments, the requestor interface 122 can include a network interface controller, a host adapter, a wireless network interface controller, and/or other suitable interface components.

The file interface 126 can include an interface component suitable to retrieve the file 110 from the file storage 108. In one embodiment, the file interface 126 can include a file system driver of the operating system 106. The file system driver can be configured to locate and retrieve the file 110 from the file storage 108. In another embodiment, the file interface 126 can include a network file management component configured to retrieve the file 110 (e.g., Big Data) from the file storage 108 via a computer network (e.g., cloud storage). In further embodiments, the file interface 126 can include device drivers, communication drivers, and/or other suitable components.

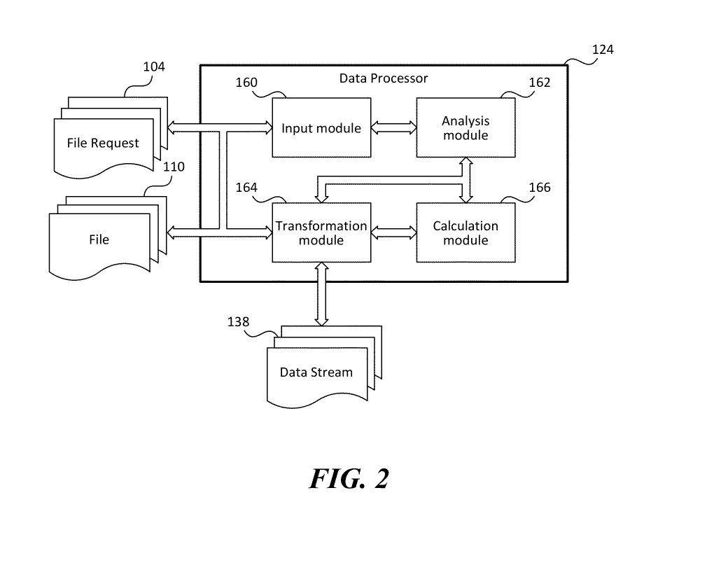

The data processor 124 can be configured to transform the requested file 110 based on the data attributes in the file request 104. In certain embodiments, the data processor 124 can include an extraction routine configured to extract a beginning, intermediate, or end section and/or a target size (e.g., 10 Mb) of the requested file 110. In other embodiments, the data processor 124 can include one or more conversion routines configured to convert at least a segment of the requested file 110 into a target format. In further embodiments, the data processor 124 may include a combination of the foregoing and/or other suitable routines. Certain embodiments of the data processor 124 are described in more detail below with reference to FIG. 2.

In certain embodiments, the requestor interface 122 may also be configured to identify one or more characteristics of the requestor 102 based on the received file request 104. The data processor 124 may then retrieve requestor data 127 from the database 125, and determine at least one of compatible file format(s), a maximum compatible file size, and/or other data attributes. For example, the file handler 120 may identify that the requestor 102 is a word processing application (e.g., Microsoft Word® 2013). Based on such identification, the data processor 124 may determine that the compatible formats for the requestor 102 include DOC, DOCX, DOT, HTM, HTML, etc., and the maximum file size is 32 Mb. In other embodiments, at least one of the foregoing data attributes of the requestor 102 may be included, for example, as metadata, in the file request 104.

In operation, the requestor 102 transmits the file request 104 to the requestor interface 122 of the file handler 120. As discussed above, in certain embodiments, the file request 104 can include a file identifier and one or more sets of attribute designators and data attributes. In other embodiments, the file request 104 may include only the file identifier. In further embodiments, the requester interface 122 may automatically detect certain characteristics and/or data attributes for the requestor 102.

The requestor interface 122 then communicates the received file identifier, optional attribute designators, and any received and/or detected data attributes to the data processor 124 for further processing. The data processor 124 then determines the file 110 to be accessed and related target data attributes. In one embodiment, the data processor 124 parses the received file request 104 to determine the file identifier and any data attributes as indicated by corresponding attribute designators. For example, the data processor 124 can mark a string segment that is between two successive attribute designators as a data attribute. For instance, in one example above, the string segment “@head@” may be parsed to indicate that “head” is a data attribute for the file request 104. In other embodiments, the data processor 124 may perform keyword detection and/or other suitable techniques to determine the data attributes.

In yet other embodiments, the data processor 124 may also modify and/or supplement the data attributes determined from the file request 104 with one or more automatically detected data attributes. For instance, in another example above, the string segment “@[10Mb]@” may be parsed to indicate a target file size of 10 Mb. However, if the requestor data 127 indicates that the maximum file size compatible with the requestor 102 is only 5 Mb, the data processor 124 may modify the target file size from 10 Mb to 5 Mb.

In further embodiments, the data processor 124 may also determine if the operation in the file request 104 is likely to fail based on the requestor data 127. For example, if the file request 104 does not specify a target file size for the file 110, and the data processor 124 determines that a size of the file 110 is greater than a maximum size for the requestor 102 (e.g., Microsoft Word® 2013), the data processor 124 may perform at least one of the following:
Raising an alarm to the requestor 102;
Modifying the file request 102 with default data attributes (e.g., the maximum file size for the requestor 102); or
Terminating the file access operation.

The data processor 124 then transmits the file identifier to the file interface 126 to access and/or retrieve the file 110 from the file storage 108. After retrieving the file 110, the file interface 126 forwards the file 110 to the data processor 124. The data processor 124 then transforms the file 110 into one or more data streams based on the determined data attributes. In the examples above, the data processor 124 can extract the beginning segment (i.e., corresponding to “head”) or a certain size (e.g., 10 Mb) from the oldfile.txt and converts the extracted segment into a Microsoft Word® format (i.e., with a DOC extension).

The one or more data streams may then be provided to the requestor 102, for example, via one or more forks in a file system associated with the operating system 106. As used herein, the term “forks” generally refers to data streams associated with a file in a file system. The data streams may contain primary data of the file or just metadata associated with the file. One type of example forks are the alternate data streams (“ADS”) in Microsoft NTFS® file system. Thus, the one or more generated data streams may be provided to the requestor 102 as one or more ADS. In another example, the hierarchical file system provided by Apple, Inc.® allows a file to have a data fork, a resource fork, and multiple named forks. Thus, the one or more generated data streams may be provided to the requestor 102 via one or more of the named forks associated with the file. As a result, a user may conveniently open, save, and/or otherwise access the file 110 via the requestor 102 without the need for a third party utility program to modify the file 110. Further, several embodiments of the computer framework 100 can also conserve storage space on the file storage 108 because one or more data streams may be dynamically generated at runtime in response to the file request 104.

FIG. 2 is a block diagram showing embodiments of the data processor 124 in FIG. 1. As shown in FIG. 2, the data processor 124 can include an input module 160, an analysis module 162, a transformation module 164, and a calculation module 166 interconnected with one another. Each of the modules 160, 162, 164, and 166 may be a computer program, procedure, or routine, or one or more of the modules may be hardware modules.

The input module 160 can be configured to receive the file request 104 and determine the file identifier and optional data attributes from the received file request 104. For example, in one embodiment, the input module 160 can include a parser configured to parse the file request as a text string. The parser is configured to recognize that a string following an attribute designator but before the next attribute is a data attribute. The parser is also configured to recognize certain command designations. For example, the parser may be configured to recognize that the word “To” indicates a target format. In other examples, the parser may be configured to recognize “Ver” as indicating a target version and/or other suitable command designations. In other embodiments, the input module 160 may be configured to determine the foregoing information via feature detection and/or other suitable techniques. The input module 160 then transmits the determined file identifier and optional data attributes to other modules for further processing.

In certain embodiments, the analysis module 162 can be configured to determine if the parsed data attributes may be modified and/or supplemented. For example, in one embodiment, the requestor interface 122 (FIG. 1) may detect and communicate one or more characteristics (e.g., application type, version, etc.) of the requestor 102 (FIG. 1) to the input module 160. In response, the analysis module 162 may retrieve related requestor data 127 (FIG. 1) from the database 125 (FIG. 1). If the requestor data 127 are in conflict with the parsed data attributes, the analysis module 162 may indicate an alarm indicating the conflict, adjust the parsed data attributes based on the requestor data 127, and/or perform other suitable operations. In other embodiments, the analysis module 162 may indicate to the requestor 102 that the requested file operation may fail.

The calculation module 166 may include routines configured to perform certain types of calculations to facilitate operations of other modules. In one example, the calculation module 166 can include one or more comparators that compares parsed data attributes with the requestor data 127. For instance, the calculation module 166 may include a comparator that compares a compatible file size of the requestor data 127 to a file size in the parsed data attributes. The calculation module 166 may also include a comparator that compares a file format in the requestor data 127 to that in the parsed data attributes. In further examples, the calculation module 166 can include linear regression, polynomial regression, interpolation, extrapolation, and/or other suitable subroutines. In further examples, the calculation module 166 can also include counters, timers, and/or other suitable routines.

The transformation module 164 may be configured to transform the file 110 into one or more data streams 138 according to the determined data attributes. For example, in one embodiment, the transformation module 164 can include an extraction routine configured to extract a beginning, intermediate, or end section and/or a target size (e.g., 10 Mb) of the requested file 110. In other embodiments, the transformation module 164 can include one or more conversion routines configured to convert at least a segment of the requested file 110 into a target format. In yet further embodiments, the transformation module 164 may include compression routines configured to compress at least a segment of the requested file 110 to have a target file size and/or format. In further embodiments, the transformation module 164 may include a combination of the foregoing and/or other suitable routines.

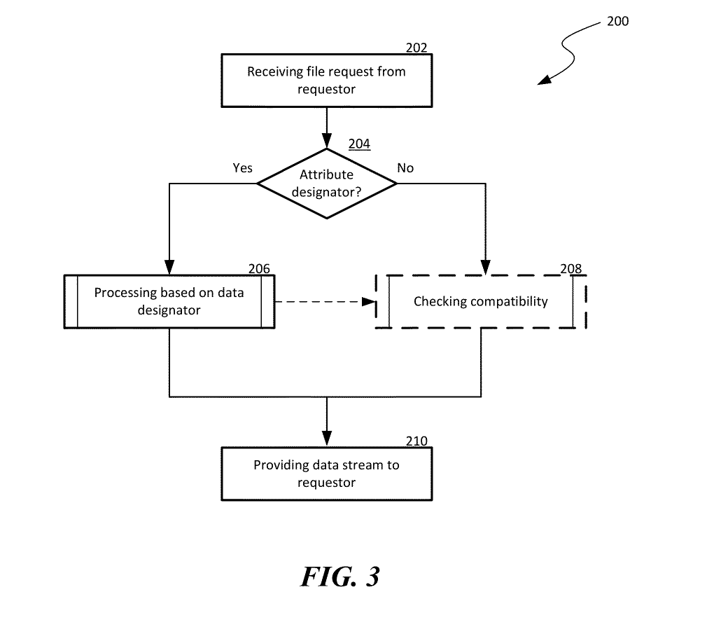

FIG. 3 is a flowchart showing a process 200 of dynamically generating data streams in accordance with embodiments of the present technology. Even though the process 200 is described below with reference to the computer framework 100 of FIG. 1 and the software components/modules of FIG. 2, the process 200 may also be applied in other systems with additional or different hardware and/or software components.

As shown in FIG. 3, the process 200 can include receiving a file request from a requestor (e.g., an application) at stage 202. In one embodiment, the file request can include a text string representing a file identifier. In another embodiment, the file request can include a text string representing a file identifier and one or more sets of attribute designators and data attributes, as discussed above with reference to FIG. 1.

The process 200 then includes a decision stage 204 to determine if the received file request includes at least one attribute designator in the text string. As described above with reference to FIG. 1, in certain embodiments, the attribute designators may include one or more select characters, symbols, punctuations, or other suitable markers. As such, if the file request includes any of the one or more markers, the process 200 may indicate that an attribute designator exists in the file request. In other embodiments, the process 200 may detect the attribute designator via feature detection and/or other suitable techniques.

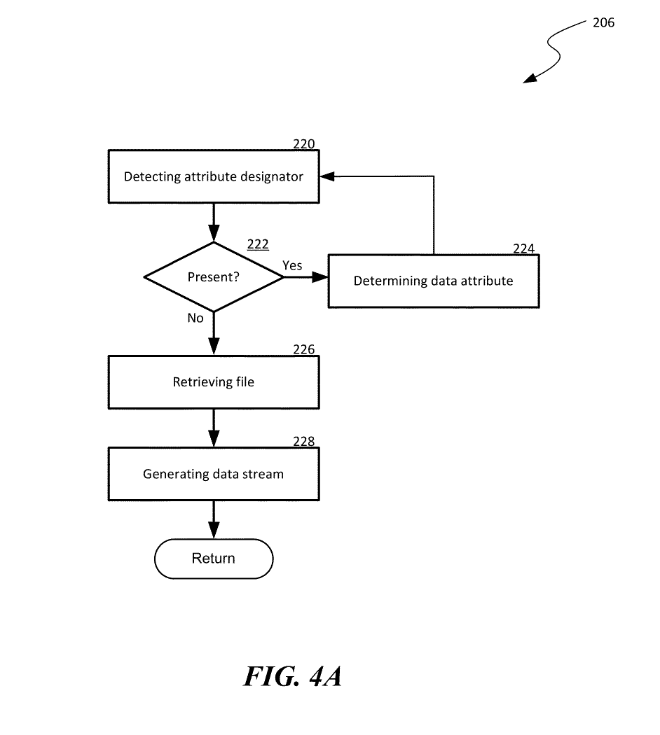

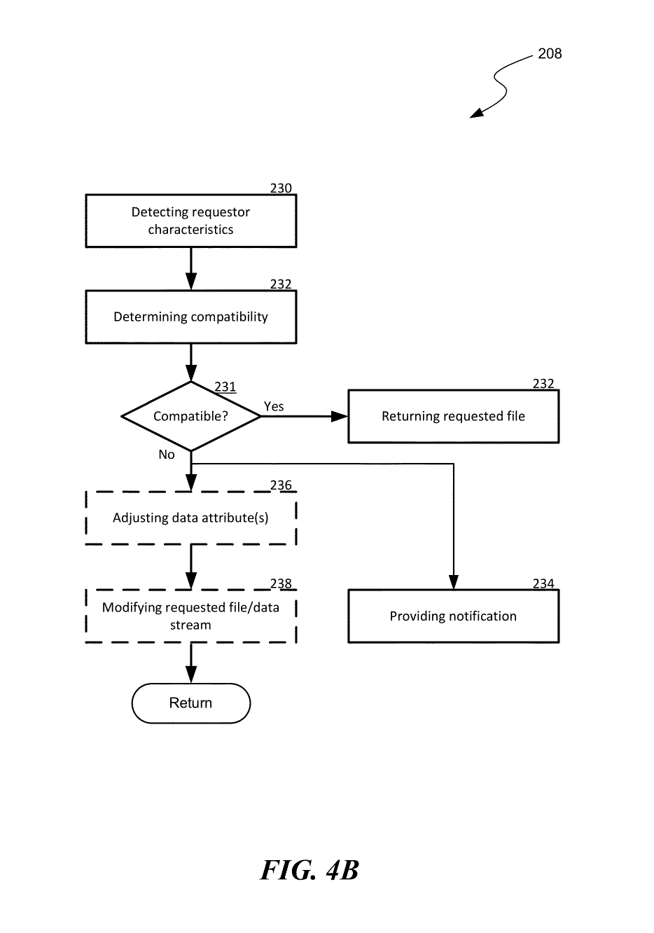

In response to determining that the file request includes at least one attribute designator, the process 200 proceeds to processing the file request to dynamically generate one or more data streams based on one or more data attributes associated with the at least one attribute designator at stage 206. Embodiments of processing the file request based on one or more data attributes are described in more detail below with reference to FIG. 4A. Otherwise, the process 200 proceeds to an optional stage 208 (shown in phantom lines) for checking compatibility between the requested file and the requestor at stage 208. Embodiments of checking compatibility are described in more detail below with reference to FIG. 4B. Optionally, in certain embodiments, the process 200 may also include checking compatibility between the generated one or more data streams and the requestor at stage 208. In other embodiments, the process 200 may proceeds directly to providing the generated one or more data streams to the requestor at stage 210.

FIG. 4A is a flow diagram illustrating embodiments of a process 206 of dynamically generating data streams in accordance with embodiments of the present technology. As shown in FIG. 4A, the process 206 includes detecting an attribute designator at stage 220. At stage 222, in response to determining that an attribute designator is detected, the process 206 includes determining a data attribute at stage 224. In one embodiment, a data attribute is determined as a string segment that immediately follows the detected attribute designator. In another embodiment, a data attribute is determined as a string segment that ends before the next attribute designator. In further embodiments, a data attribute may be determined in other suitable manners.

The process 206 then reverts to detecting an additional attribute designator at stage 220. If an additional attribute designator is present, the process 206 includes determining an additional data attribute at stage 224. If no additional attribute designator is present, the process 206 proceeds to retrieving a requested file based on the file identifier at stage 226. In one embodiment, the file may be retrieved from a local storage location (e.g., a hard drive). In other embodiments, the file may be retrieved from a network storage location (e.g., cloud storage) and/or other suitable locations.

The process 206 then include generating a data stream from the retrieved file based on the determined data attributes at stage 228. In one embodiment, the data stream can be generated by extracting a beginning, intermediate, or end segment of a certain file size from the retrieved file. For example, the extracted segment may include a beginning segment of a Microsoft Word® file of 10 Mb. In another example, the extracted segment may include an end segment of a Microsoft Excel® file of 1000 rows.

In another embodiment, the data stream may be generated by converting at least a segment of the file into a file format indicated by the determined data attribute. For example, the data stream may be generated by converting a beginning segment of a Microsoft Word® file of 10 Mb into a text file format. In another example, the data stream may be generated by converting an end segment of a Microsoft Excel® file of 1000 rows into comma separated values. In a further example, the data stream may be generated by converting the entire file into a target file format.

In certain embodiments, the data stream may be generated by performing both format conversion and compression on at least a segment of the file. For example, a data stream may be generated by converting/compressing a retrieved file in bitmap format into a JPEG format. As a result, the generated data stream would be of a different file format and file size than the original retrieved file. In further embodiments, the foregoing data stream may also be generated by performing certain editing operations on at least a segment of the file. For example, data attributes “@Rotate90,” “@Rotate180,” “@FlipHor,” or “@FlipVer” may be appended to a file request to indicate an operation of rotating 90°, rotating 180°, flipping horizontal, or flipping vertical, respectively. In yet further embodiments, the data stream may be generated by performing a combination of the foregoing and/or other suitable techniques. The process 206 then returns.

FIG. 4B is a flow diagram illustrating embodiments of a process 208 of checking compatibility in accordance with embodiments of the present technology. As shown in FIG. 4B, the process 208 includes detecting requestor characteristics at stage 230. The requestor characteristics can include at least one of an application type, version, compatible file format(s), a maximum file size, and/or other suitable information. In one embodiment, the requestor characteristics may be detected by analyzing metadata included with the file request. The metadata may be encoded with at least of the foregoing information. In other embodiments, at least some of the requestor characteristics may be derived by, for example, accessing a database (e.g., the database 125 of FIG. 1) based on an application type and/or version.

The process 208 then includes determining compatibility between the requestor and the requested file (or generated data stream) at stage 232. In one embodiment, determining the compatibility can include comparing respective characteristics of the requestor to those of the requested file. In one example, the requestor can be Microsoft Word® 2013, and the requested file can have a file size of 100 Mb. Then, the requested file would not be compatible with the requestor because the maximum file size of Microsoft Word® 2013 is only 32 Mb.

In response to that an indication of compatibility, the process 208 proceeds to returning requested file (or data stream) at stage 232. Otherwise, the process 208 includes providing notification to the requestor at stage 234. Optionally, the process 208 may also include adjusting data attributes based on the determined compatibility at stage 236. For instance, in the previously example, a target file size for the requested file may be reduced from 100 Mb to 32 Mb by extracting a beginning segment of the requested file. In another example, a target file format compatible with the requestor may be assigned to the file request. In further examples, a combination of the foregoing and/or other suitable operations may be performed. The process 208 may then include modifying the requested file (or data stream) based on the adjusted data attributes at stage 238, as described in more detail above with reference to FIG. 4A. The process 208 then returns.

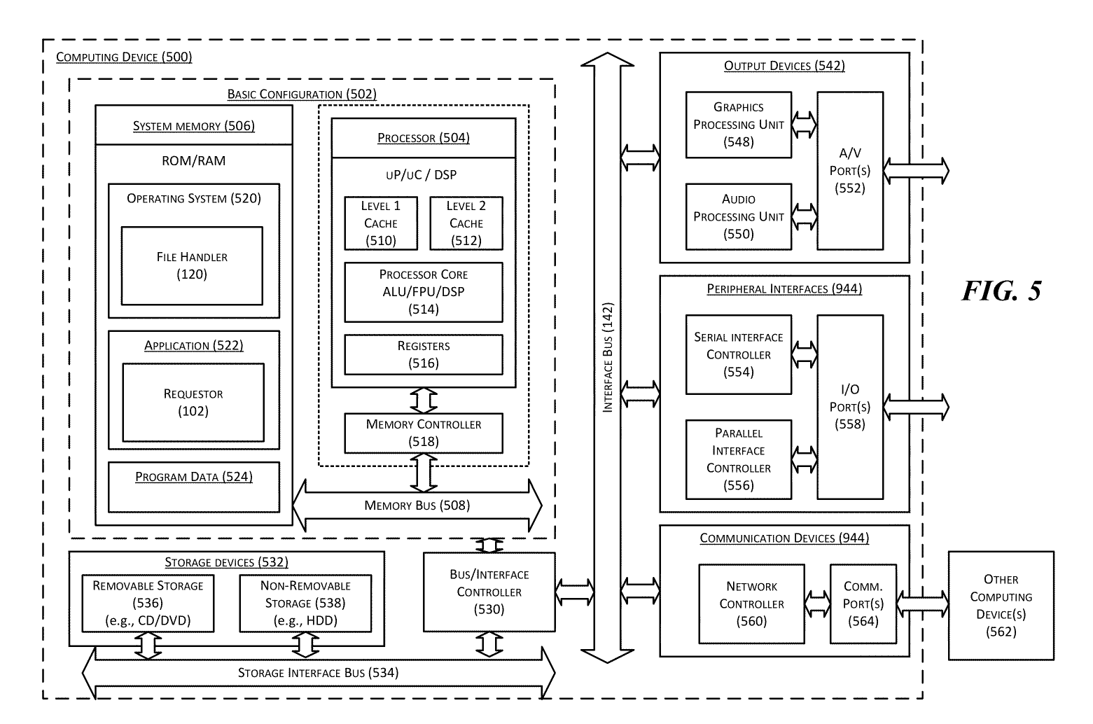

FIG. 5 is a computing device 500 suitable for certain components of the computer framework 100 in FIG. 1. In a very basic configuration 502, computing device 500 typically includes one or more processors 504 and a system memory 506. A memory bus 508 may be used for communicating between processor 504 and system memory 506.

Depending on the desired configuration, the processor 504 may be of any type including but not limited to a microprocessor (μP), a microcontroller (μC), a digital signal processor (DSP), or any combination thereof. The processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, one or more applications 522, and program data 524. The application 522 may include, for example, the requestor 102 (FIG. 1). This described basic configuration 502 is illustrated in FIG. 5 by those components within the inner dashed line.

The computing device 500 may have additional features or functionality, and additional interfaces to facilitate communications between basic configuration 502 and any other devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500. The term “computer storage medium” excludes propagated signals and communication media.

The computing device 500 may also include an interface bus 540 for facilitating communication from various interface devices (e.g., output devices 542, peripheral interfaces 544, and communication devices 546) to the basic configuration 502 via bus/interface controller 530. Example output devices 542 include a graphics processing unit 548 and an audio processing unit 550, which may be configured to communicate to various external devices such as a display or speakers via one or more NV ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 500 may also be implemented as a personal computer including both laptop computer and non-laptop computer configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method performed by a computer having a processor, the method comprising:
with the processor,
receiving a request from an application to open a file, the request having a file identifier identifying the file, an attribute designator, and a data attribute delineated from the file identifier by the attribute designator;
retrieving data of at least a portion of the file based on the determined file identifier;
dynamically generating a data stream of the file in response to the received request to open the file by transforming the retrieved data according to the data attribute of the request; and
supplying the generated data stream to the application.

2. The method of claim 1 wherein receiving the request includes receiving a request having a data attribute identifying at least one of a size, format, or segment of the requested file.

3. The method of claim 1 wherein:
receiving the request includes receiving a request having a data attribute identifying at least one of a size, format, editing operation, or segment of the requested file; and
dynamically generating the data stream includes at least one of:
reducing a size of the retrieved data according to the size identified by the data attribute;
converting a format of the retrieved data into the format identified by the data attribute;
editing the requested file based on the editing operation identified by the data attribute; or
extracting a portion of the retrieved data according to the segment identified by the data attribute.

4. The method of claim 1 wherein:
receiving the request includes receiving a request having a data attribute identifying a segment of the requested file, the segment including at least one of a beginning, intermediate, or end portion of the retrieved data; and
dynamically generating the data stream includes extracting a portion of the retrieved data according to the segment identified by the data attribute.

5. The method of claim 1 wherein:
receiving the request includes receiving a request having a data attribute identifying a segment of the requested file, the segment including at least one of a beginning, intermediate, or end portion of the retrieved data, the beginning, intermediate, or end portion individually having a default size; and
dynamically generating the data stream includes extracting a portion of the retrieved data according to the segment identified by the data attribute, the extracted portion having a size generally matching the default size.

6. The method of claim 1 wherein:
receiving the request includes receiving a request having a data attribute identifying a version of the requested file; and
retrieving the data includes retrieving data of the file according to the version identified by the data attribute.

7. The method of claim 1 wherein:
receiving the request includes receiving a request having a data attribute identifying a size, format, segment, and version of the requested file;
retrieving the data includes retrieving data of the file according to the version identified by the data attribute; and
dynamically generating the data stream includes:
reducing a size of the retrieved data according to the size identified by the data attribute;
converting a format of the retrieved data into the format identified by the data attribute; or
extracting a portion of the retrieved data according to the segment identified by the data attribute.

8. The method of claim 1 wherein:
the attribute designator is a first attribute designator;
the data attribute is a first data attribute;
the request further includes a second designator and a second data attribute;
the first designator is the same as the second designator; and
the first data attribute is different than the second data attribute.

9. A computing system, comprising:
a processor and a file storage operatively coupled to the processor, the processor being configured to:
detect one or more data attributes of an application in response to receiving a request from the application for a file, the request having a file identifier identifying the file;
retrieve data of the file from the file storage based on the file identifier;
generate a data stream from the retrieved data according to the detected one or more data attributes in response to the received request for the file; and
supply the generated data stream to the application.

10. The computer system of claim 9 wherein the one or more data attributes include a file size or file format compatible with the application.

11. The computer system of claim 9 wherein:
the one or more data attributes include a file size compatible with the application;
the processor is also configured to:
determine if a size of the requested file exceeds the file size compatible with the application; and
in response to determining that the size of the requested file exceeds the file size compatible with the application, reduce a size of the retrieved data to be lower than the file size compatible with the application when generating the data stream.

12. The computer system of claim 9 wherein:
the one or more data attributes include a file size and a plurality of file formats compatible with the application;
the processor is also configured to:
determine if a size of the requested file exceeds the file size compatible with the application; and
in response to determining that the size of the requested file exceeds the file size compatible with the application, converting the retrieved data into one of the plurality of file formats compatible with the application when generating the data stream, a size of the converted data being lower than the file size compatible with the application.

13. The computer system of claim 9 wherein:
the one or more data attributes include a file size compatible with the application;
the processor is also configured to:
determine if a size of the requested file exceeds the file size compatible with the application; and
in response to determining that the size of the requested file exceeds the file size compatible with the application, extract a segment of the retrieved data when generating the data stream.

14. The computer system of claim 9 wherein:
the one or more data attributes include a file size compatible with the application;
the processor is also configured to:
determine if a size of the requested file exceeds the file size compatible with the application; and
in response to determining that the size of the requested file exceeds the file size compatible with the application, extract a segment of the retrieved data when generating the data stream, the extracted segment having a size lower than the file size compatible with the application.

15. The computer system of claim 9 wherein:
the one or more data attributes include a file size compatible with the application;
the processor is also configured to:
determine if a size of the requested file exceeds the file size compatible with the application; and
in response to determining that the size of the requested file exceeds the file size compatible with the application, extract a default segment of the retrieved data when generating the data stream, the extracted segment being one of a beginning, intermediate, or end segment of the retrieved data and having a default size lower than the file size compatible with the application.

16. The computer system of claim 9 wherein:
the one or more data attributes include a file format compatible with the application;
the processor is also configured to:
determine if a format of the requested file is different than the file format compatible with the application; and
in response to determining that the format of the requested file is different than the file format compatible with the application, converting the retrieved data to be in the file format compatible with the application when generating the data stream.

17. A computer readable storage medium containing instructions, when executed by a processor, causing the processor to perform a method comprising:
receiving a request from an application to open a file, the request having a file identifier identifying the file,
retrieving data of the file based on the file identifier;
detecting a file size and/or file format that are compatible with the application in response to receiving the request;
determining if the request also includes an attribute designator and a data attribute delineated from the file identifier by the attribute designator;
in response to determining that the request includes an attribute designator and a data attribute,
parsing the received request to determine the data attribute in the request based on the attribute designator; and
generating a data stream by transforming the retrieved data of the file according to the determined data attribute; and
supplying the generated data stream to the application in response to the received request to open the file.

18. The computer readable storage medium of claim 17 wherein the method further includes:
determining if a size of the data stream generated by transforming the retrieved data of the file according to the determined data attribute exceeds the file size compatible with the application; and
in response to determining that the size of the generated data stream exceeds the file size compatible with the application, reducing the size of the generated data stream to a size lower than the file size compatible with the application.

19. The computer readable storage medium of claim 17 wherein the method further includes:
determining if a format of the data stream generated by transforming the retrieved data of the file according to the determined data attribute is compatible with the file format compatible with the application; and
in response to determining that the format of the generated data stream is not compatible with the file size compatible with the application, converting the generated data stream into the file format compatible with the application.

20. The computer readable storage medium of claim 17 wherein the method further includes:
determining if a size or a format of the data stream generated by transforming the retrieved data of the file according to the determined data attribute is compatible with the file format compatible with the application; and
in response to determining that the size of the requested file exceeds the file size compatible with the application or that the format of the requested file is not compatible with the file format compatible with the application, indicating to the application at least one of that:
the requested file cannot be opened without modification;
the size of the requested file has been reduced; or
the format of the requested file has been changed.
